(19) United States
(12) Patent Application Publication
(10) Pub. No.: US 2026/0330710 A1
(43) Pub. Date: Oct. 22, 2026

(54) CONTROL APPARATUS

(71) Applicant: TOYOTA JIDOSHA KABUSHIKI KAISHA, Aichi-ken (JP)

(72) Inventor: Nobuyuki MATSUNO, Edogawa-ku (JP)

(21) Appl. No.: 19/531,666

(22) Filed: Feb. 6, 2026

(30) Foreign Application Priority Data
Feb. 13, 2025 (JP) 2025-021839

(51) Int. Cl. G06T 11/10

(52) U.S. Cl. CPC G06T 11/10; G06T 2210/56

(57) ABSTRACT

A control apparatus includes a communication interface that communicates with a mobile object that acquires a captured image of a subject and information on distance to the subject, and a controller that outputs an image for display in which a point cloud generated based on the information on distance and corresponding to a surface of the subject is superimposed on the captured image. The point cloud has reduced density, and respective points are drawn with different areas according to distance from the mobile object.

### CROSS-REFERENCE TO RELATED APPLICATION

This application claims priority to Japanese Patent Application No. 2025-021839, filed on Feb. 13, 2025, the entire contents of which are incorporated herein by reference.

### TECHNICAL FIELD

The present disclosure relates to a control apparatus.

### BACKGROUND

Various technologies for remotely controlling mobile objects such as traveling robots have been proposed. For example, Patent Literature (PTL) 1 discloses a technology for displaying a marker indicating a target position for which a mobile object is heading, in a remote control apparatus.

### CITATION LIST

### Patent Literature

PTL 1: JP 2022-173195 A

### SUMMARY

Although the difficulty of remote control varies depending on the environment around the movement paths, the movement speeds, and the like of mobile objects, there is room for improvement in the operability of remote control of the mobile objects.

Hereinafter, a control apparatus and the like that enable improvement in the operability of remote control of a mobile object will be disclosed.

A control apparatus according to the present disclosure includes:
a communication interface configured to communicate with a mobile object that acquires a captured image of a subject and information on distance to the subject; and
a controller configured to output an image for display in which a point cloud generated based on the information on distance and corresponding to a surface of the subject is superimposed on the captured image, the point cloud having reduced density, and respective points being drawn with different areas according to distance from the mobile object.

The control apparatus according to the present disclosure can improve the operability of remote control of a mobile object.

### BRIEF DESCRIPTION OF THE DRAWINGS

In the accompanying drawings:

FIG. 1 is a diagram illustrating an example of a configuration of a remote control system;

FIG. 2A is a sequence diagram illustrating an example operation procedure of the remote control system;

FIG. 2B is a sequence diagram illustrating an example operation procedure of the remote control system; and

FIG. 3 is a diagram illustrating an example of a screen for display.

### DETAILED DESCRIPTION

An embodiment will be described below.

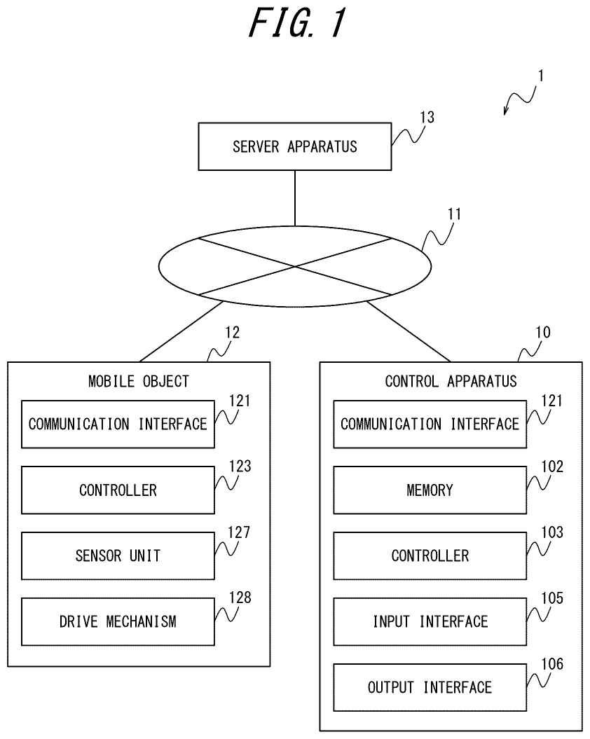

FIG. 1 is a diagram illustrating an example configuration of a remote control system according to the embodiment. The remote control system 1 includes a mobile object 12 and a control apparatus 10 for remotely controlling the mobile object 12. The mobile object 12 and the control apparatus 10 are connected to each other communicably via the network 11 through the mediation of the server apparatus 13. The mobile object 12 is, for example, a traveling robot for transporting goods in a warehouse, commercial facility, etc. The control apparatus 10 is an information processing apparatus equipped with communication functions and an interface for user operation, such as a PC (personal computer), smartphone terminal, tablet terminal, or an operation terminal for the mobile object 12. The network 11 may be, for example, the Internet, but may also include an ad hoc network, a local area network (LAN), a metropolitan area network (MAN), or other networks or any combination thereof. The server apparatus 13 is, for example, a server computer belonging to a cloud computing system or other computing system, implementing various functions.

In the remote control system 1 of this embodiment, the control apparatus 10 includes a communication interface 101 that communicates with the mobile object 12 that acquires a captured image of a subject and information on distance to the subject (hereinafter referred to as distance information), and a controller 103 that outputs an image for display in which a point cloud generated based on the distance information and corresponding to a surface of the subject is superimposed on the captured image, the point cloud having reduced density, and respective points being drawn with different areas according to distance from the mobile object 12. When displaying various targets, obstacles, etc. in the environment where the mobile object 12 travels by superimposing a point cloud using distance information on the captured image, reducing the density of the point cloud allows for a reduction in the processing load of the control apparatus 10, enabling faster image processing while displaying each point with different areas according to distance, thus allowing for a more realistic representation of three-dimensionality. Thus, it becomes possible to improve the operability in the remote operation of the mobile object 12.

As shown in FIG. 1, the control apparatus 10 includes a communication interface 101, a memory 102, a controller 103, an input interface 105, and an output interface 106.

The communication interface 101 is equipped with a module compliant with communication standards such as wired LAN, wireless LAN, LTE (Long Term Evolution), 4G (4th Generation), 5G (5th Generation), and connects to the network 11 via a router or base station. Through the communication interface 101, the control apparatus 10 communicates with the mobile object 12 via the server apparatus 13 through the network 11.

The memory 102 includes a semiconductor memory, magnetic memory, or optical memory. The semiconductor memory includes RAM (Random Access Memory) or ROM (Read Only Memory). RAM includes SRAM (Static RAM) or DRAM (Dynamic RAM), and ROM includes EEPROM (Electrically Erasable Programmable ROM). The memory 102 stores the control program of the control apparatus 10, information necessary for operation, or operation results.

The controller 103 includes processors such as a CPU (Central Processing Unit), GPU (Graphics Processing Unit), or dedicated circuits such as FPGA (Field-Programmable Gate Array) or ASIC (Application-Specific Integrated Circuit), and executes information processing of the control apparatus 10.

The input interface 105 is equipped with a microphone, capacitive keys, touch screen, pointing devices, or physical switches such as physical keys and joysticks, and accepts user operations, sending input information corresponding to the operation to the controller 103.

The output interface 106 is equipped with a speaker or display. The display includes an LCD (Liquid Crystal Display) or OLED (Organic Light Emitting Diode) and outputs the processing results of the controller 103.

The mobile object 12 is a traveling robot equipped with a mechanism for transporting cargo and a traveling mechanism that includes wheels, and has a communication interface 121, a controller 123, a sensor unit 127, and a drive mechanism 128. The communication interface 121 supports communication standards such as wired LAN, wireless LAN, LTE, 4G, and 5G, and performs information communication with the control apparatus 10. The controller 123 includes a processor such as a CPU or a dedicated circuit such as an ASIC, and integrally controls the operation of the mobile object 12 while communicating with the control apparatus 10 via the communication interface 121. The sensor unit 127 includes a camera and a distance sensor. The camera is a visible light camera that acquires captured images using visible light and is installed in a position where it can capture the environment in front of the mobile object 12 when it moves. The distance sensor is a sensor for measuring the distance to an object and includes ultrasonic sensors, infrared sensors, and LiDAR (Light Detection and Ranging) sensors. The distance sensor may include a depth camera. The distance sensor is installed at a position of the mobile object 12 where it can measure the distance to objects included in the imaging range of at least the visible light camera. In addition, the sensor unit 127 includes an acceleration sensor, a gyro sensor, a distance sensor, a GPS (Global Positioning System) module, etc. The sensor unit 127 acquires information such as captured images, distance measurement results, detection results regarding the surrounding environment, and detection results of the motion state of the mobile object 12, and sends it to the controller 103. The controller 103 sends captured images, etc., to the control apparatus 10 via the communication interface 121 and controls the operation of the drive mechanism 128 based on instructions from the control apparatus 10. The drive mechanism 128 includes wheels for traveling and motors and actuators that drive the wheels, and realizes the operations of the mobile object 12 such as moving forward, backward, and turning based on instructions from the controller 123. Power is supplied from a battery mounted on the mobile object 12 to each of these components.

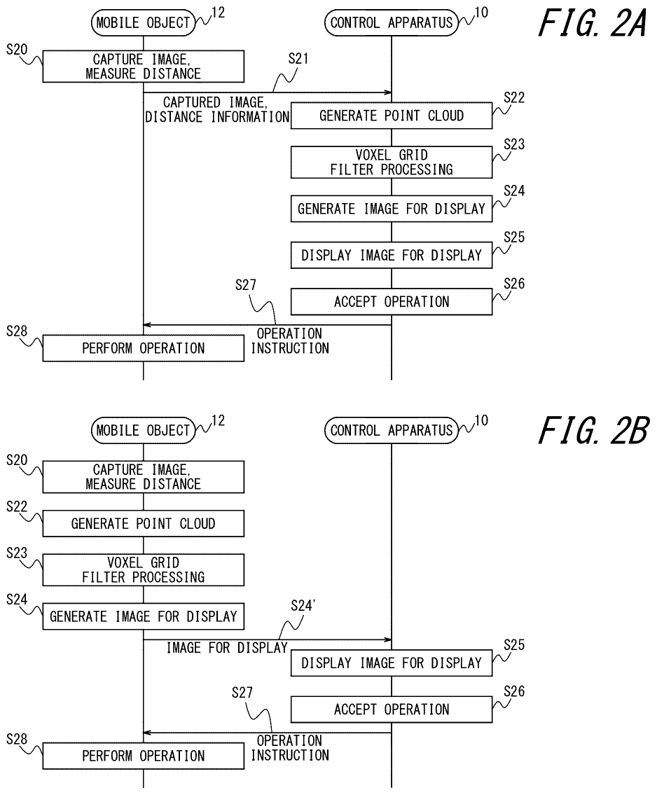

FIG. 2A is a sequence diagram for explaining an example of the operation procedure of the remote control system 1. FIG. 2A shows an example of the procedure related to the cooperative operation of the mobile object 12 and the control apparatus 10, which is executed at any cycle, for example, every few tens of microseconds, when the mobile object 12 moves.

The mobile object 12 performs imaging and distance measurement of subjects in the surrounding environment while traveling (S20) and sends the captured images and distance information to the control apparatus 10 (S21). Under the control of the controller 123, the visible light camera of the sensor unit 127 captures the environment around the mobile object 12, for example, the environment in front of the direction of travel, and the distance sensor measures the distance to objects included in the imaging range. Then, the controller 123 generates distance information using the measurement results from the distance sensor. For example, the controller 123 generates distance information by deriving the spatial coordinates of each reflection point on the subject when scanning the imaging range of the visible light camera with sensors such as LiDAR. Alternatively, the controller 123 generates distance information by deriving spatial coordinates corresponding to each pixel of the subject image using depth images from a depth camera. Then, the controller 123 sends the captured image from the visible light camera and the distance information via the communication interface 121.

Next, the control apparatus 10 processes the captured image and distance information obtained from the mobile object 12 to generate a point cloud corresponding to the subject (S22), applies voxel grid filter processing to the point cloud (S23), and generates an image for display (S24). First, the controller 123 generates a point cloud corresponding to each spatial coordinate included in the distance information. At this time, the point cloud is generated with a density corresponding to the distribution of spatial coordinates. Through voxel grid filter processing, the point cloud is divided into arbitrary unit spaces, for example, every few cubic centimeters, and by retaining representative points in each unit space while deleting other points, the density of the point cloud is reduced. Next, the controller 123 draws each point in the reduced density point cloud with an area corresponding to the distance from the mobile object. Each point can be drawn in any shape, such as circular or elliptical, with points farther away being smaller and points closer being larger. Furthermore, the controller 123 may draw each point in any different color corresponding to the distance from the mobile object. Then, the controller 123 performs processing such as noise removal, distortion correction, and identification of various objects reflected in the captured image, and superimposes the drawn point cloud onto the corresponding subject in the captured image to generate an image for display. Information that associates the coordinate system in the captured image with the coordinate system in the measurement results of the distance sensor is stored in advance in the memory 122, and using this information, the controller 123 can associate the subject in the captured image with the point cloud and superimpose the point cloud onto the captured image.

In generating the image for display, the controller 123 of the control apparatus 10 can determine the area of each point in the point cloud based on the camera projection formula of any camera model. The camera model includes pinhole camera models, double-sphere camera models, etc. For example, let the position of point P in the camera coordinate system be (x, y, z), and let the pixel position where point P is displayed in the captured image be point P′(u, v), then the camera projection formulas u and v are expressed as follows.

u=u(x, y, z), v=v(x, y, z)

Then, the radius r of the circle when drawing point P as a circle is calculated by the following (Equation 1). Here, voxel_size indicates the size of the unit space.

r=max(∂u/∂x+∂u/∂y+∂u/∂z, ∂v/∂x+∂v/∂y+∂v/∂z)* voxel_size/2 (Equation 1)

In the above (Equation 1), instead of using the maximum value of the partial derivatives of u and v with respect to x, y, and z, the minimum value, median, or average value may be used. Alternatively, the axes r_u and r_v of the ellipse when drawing point P as an ellipse are derived by the following (Equation 2).

r_u=(∂u/∂x+∂u/∂y+∂u/∂z)*voxel_size/2 (Equation 2)

r_v=(∂v/∂x+∂v/∂y+∂v/∂z)*voxel_size/2

By drawing each point with a circle or ellipse whose area is determined as described above, the area of each point corresponding to the distance can be obtained without being significantly affected by lens distortion in the captured image.

Then, the control apparatus 10 displays the image for display to the user (S24). The controller 103 displays the image for display on the display of the output interface 106.

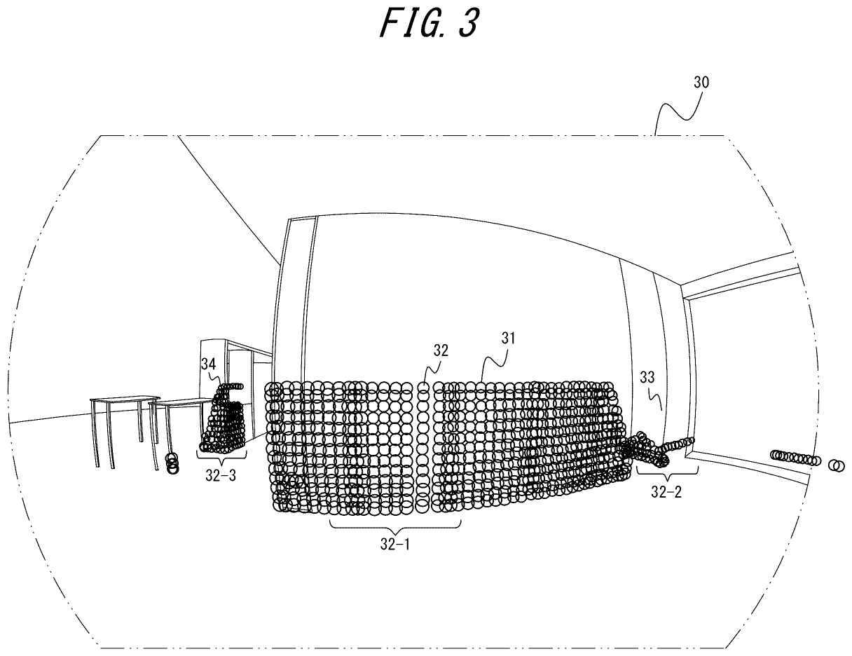

FIG. 3 shows an example of the display of the image for display. For example, the image for display 30 includes an image of the indoor environment of the office captured by the mobile object 12 moving within the office. In the image for display 30, a point cloud 32 superimposed on the subjects 31, 33, and 34 is shown. Here, for the point cloud 32-1 corresponding to the subject 31, which is relatively close to the mobile object 12, each point is drawn as a circle with a relatively large area, while for the point clouds 32-2 corresponding to the subject 33, which is relatively far from the mobile object 12, and the point cloud 32-3 corresponding to the subject 34, each point is drawn as a circle with a relatively small area. Here, the nearby point cloud 32-1 may be drawn in a color with a more prominent brightness or saturation than the distant point clouds 32-2 and 32-3. Each point may be semi-transparent. Additionally, each point of the point cloud 32 may be drawn using an ellipse. With such an image for display, the user can perceive the environment in front of the mobile object 12 with a more realistic depth.

Returning to FIG. 2A, the control apparatus 10 accepts operations performed by the user based on the image for display (S26) and sends operation instructions to the mobile object 12 based on the operations (S27). The controller 103 generates operation instructions based on the user's operations on the input interface 105 and sends the operation instructions via the communication interface 121. The operation instructions are, for example, instructions to accelerate, decelerate, stop, turn, etc. Then, the mobile object 12 executes actions corresponding to the operation instructions, namely, acceleration, deceleration, stopping, turning, etc. (S28).

By the control apparatus 10 presenting the image for display to the user through the above procedure, the user can perform remote control while checking the front of the mobile object 12. At that time, the visibility in the forward direction during operation is improved for the user. Thus, it becomes possible to improve the operability in the remote operation of the mobile object 12.

In the variation example, part or all of the processing from point cloud generation to image for display generation may be executed by the controller 123 of the mobile object 12, and the controller 123 may receive information about the processing results from the mobile object 12. For example, in FIG. 2B, the steps are shown for generating a point cloud (S22), performing voxel grid filter processing (S23), and generating an image for display (S24) in the controller 123 of the mobile object 12, sending the image for display from the mobile object 12 to the control apparatus 10 (S24′), and displaying the operation image for display received by the control apparatus 10 (S25). In this way, the load of image processing can be appropriately distributed between the mobile object 12 and the control apparatus 10.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A control apparatus comprising:
a communication interface configured to communicate with a mobile object that acquires a captured image of a subject and information on distance to the subject; and
a controller configured to output an image for display in which a point cloud generated based on the information on distance and corresponding to a surface of the subject is superimposed on the captured image, the point cloud having reduced density, and respective points being drawn with different areas according to distance from the mobile object.

2. The control apparatus according to claim 1, wherein when a first point is drawn with a first area, a second point whose distance from the mobile object is greater than that of the first point is drawn with a second area that is smaller than the first area.

3. The control apparatus according to claim 2, wherein the first and second points are drawn in different colors from each other.

4. The control apparatus according to claim 1, wherein the density of the point cloud is reduced by dividing a region of the point cloud into unit regions and leaving a representative point in each unit region.
